(19) United States
(12) Patent Application Publication
(10) Pub. No.: US 2002/0173345 A1
(43) Pub. Date: Nov. 21, 2002

(54) Method and system for phone note taking

(76) Inventors: Jan Ingemar Swerup, Knivsta (SE); Peter Goodings, Glossop (GB)

Correspondence Address: JENKENS & GILCHRIST, 3200 Fountain Place, 1445 Ross Avenue, Dallas, TX, 75202-2799, US

(21) Appl. No.: 09/945,199

(22) Filed: Aug. 31, 2001

Related U.S. Application Data
(60) Provisional application No. 60/291,905, filed on May 17, 2001.

(51) Int. Cl. H04M 1/00

(52) U.S. Cl. 455/566; 455/556; 455/567

(57) ABSTRACT

Upon establishment of a call, a screen of a mobile station automatically enters into a writing-surface mode. A user of the mobile station is able to write on the screen in the writing-surface mode during the call without having to navigate a menu or other navigation system. The user can cause the screen to enter the writing-surface mode by activating a button or the like and can also press a switch button or the like in order to use the screen in writing-surface mode in either a shared or a non-shared mode. In the shared mode, notes written on the screen while in writing-surface mode can be wirelessly transmitted to another mobile station involved in the call. While in the non-shared mode, notes written while in writing-surface mode are not wirelessly transmitted.

### RELATED APPLICATIONS

This patent application claims the benefit of priority from and incorporates by reference the entire disclosure of co-pending U.S. Provisional Patent Application No. 60/291,905, filed on May 17, 2001.

### BACKGROUND OF THE INVENTION

1. Technical Field of the Invention

The present invention relates in general to methods and systems for phone note taking and, more particularly, to methods and systems for permitting easy access to phone note taking features.

2. Description of Related Art

Many telephone calls lead a participant therein to want to write something down, such as, for example, a phone number, a name, an address, or a map. In addition, what is written by one or more of the participants to the call can be something irrelevant to the call, such as, for example, information to be communicated to a person who is near to one of the participants but not involved in the call. The need to write something down while communicating on the telephone can arise suddenly and without warning. In such situations, the person who needs to write something down often has very little excess cognitive capacity available to navigate computer-like menus or icons or other navigation systems. This is especially true when, for example, the person who wants to write something down is also driving a vehicle, exercising, reading, or is otherwise mentally occupied.

Many current mobile telephones and personal digital assistance (PDAs) have a host of applications and features that necessitate menus and other navigation systems. However, these navigation systems are often cumbersome to use and require more thought and attention than is available to the person who wants to write something down while involved in the call. Therefore, these systems often require that the person involved in the call who wants to write something down either: (1) divert their attention from what the person on the other end of the call is saying in order to operate a menu or other navigation system; (2) divert their attention from their driving, exercising, or other tasks being performed at the same time as the call; and/or (3) not operate the menu system of the phone or PDA and wait until the call has been completed to write the information down.

If the person who wants to write something down waits until the call has been completed, information to be recorded may be lost from the person's memory and thus incorrectly or incompletely recorded or not recorded at all. If the person's attention is diverted from the person on the other end of the call, it may become apparent to the person on the other end of the call that the person writing something down is not listening, which can cause considerable irritation on the part of the person on the other end of the call. In addition, if attention is diverted away from driving or other important tasks being performed simultaneously with the call, an automobile accident or other undesirable effects can occur. It is, therefore, important that a person involved in a telephone call be able to easily and quickly get started in writing down whatever is desired without having to navigate a complicated menu system.

Therefore, a method and system for phone note taking that eliminates the drawbacks mentioned above and other drawbacks is needed.

### SUMMARY OF THE INVENTION

A method of accessing a writing surface of a mobile station includes establishing a call involving the mobile station and providing at least a portion of a screen of the mobile station in a writing-surface mode in response to detection of a writing-surface-mode-change condition. The writing-surface mode-change condition includes the step of establishing the call. A user of the mobile station has access to the writing surface while involved in the call.

A mobile station includes a screen adapted to operate in a writing-surface mode and a display mode and a control unit adapted to provide at least a portion of the screen in the writing-surface mode in response to detection of a writing-surface-mode-change condition. The writing-surface-mode-change condition includes establishment of a call involving the mobile station.

### BRIEF DESCRIPTION OF THE DRAWINGS

A more complete understanding of exemplary embodiments of the present invention can be achieved by reference to the following Detailed Description when taken in conjunction with the accompanying Drawings, wherein:

FIG. 1 is a block diagram illustrating a mobile station in accordance with at least one of the embodiments of the present invention; and

FIG. 2 is a flow diagram that illustrates an exemplary mode of operation of at least one embodiment of the present invention.

### DETAILED DESCRIPTION

The present invention is applicable to all mobile telephones and personal digital assistants (PDAs) that offer a writing surface. As used herein, the term mobile station includes telephones, PDAs, personal computers, and any other device that can function as a mobile telephone in a network, such as, for example, a Third Generation (3G) wireless network, including, but not limited to, those operating according to wideband code-division multiple access (WCDMA). The writing surface can be in the form of, for example, a touch screen. In a preferred embodiment of the present invention, functionality of the mobile station other than the writing function is overridden in response to establishment of a call. In this embodiment, a user of the mobile station can still reach all functions of the mobile station other than the writing function; however, to reach these other functions, operation of a menu or other navigation system is necessary.

In accordance with embodiments of the present invention, the mobile station automatically provides a writing surface in response to establishment of a call and is, therefore, ready to accept new writing or drawing input without any additional action on the part of the user. In some embodiments, the writing surface takes the place of a menu or other navigation system that is normally present when a phone call has not been established. If the user wants to use functions of the mobile station other than the writing function, the user must activate a user input of the mobile station, such as, for example, pressing an icon, moving a flip feature of the mobile station, pressing a single dedicated hard button, pressing a soft button (e.g., on a touch screen), drawing a particular character on the screen, or the like: For example, in response to opening of a flip feature of the mobile station following establishment of a call involving the mobile station, a screen or a portion of the screen becomes available as a writing surface. In order for the user to be able to write something down after the call has ended, a writing surface preferably continues to be visible and available to the user until the user presses a particular user input, such as the NO button, a special hard or soft button, or the like. The same user input, such as, for example, a hard button, a soft button, a flip feature, or the like can be used to toggle between the writing-surface mode and the display mode. In the alternative, a separate user input can be used to enter the display mode and the writing-surface mode, respectively.

In another embodiment of the present invention, the user may want to share what has been written on the writing surface with the person on the other end of the call. If, for example, the mobile station has a color display, the color of the display can be made to change from a first color used when the mobile station is in a non-shared writing-surface mode to a second color when the writing surface is in a shared mode. In such a situation, the writing surface can be, for example, yellow when in the non-shared mode, in order to remind the user of a Post-It™ note. In a similar fashion, the writing surface can be a white color when the writing surface is in shared mode (i.e., when the information being written or drawn on the writing surface is to be shared with the person on the other end of the call) in order to remind the user of a napkin. Movements of a pen or other writing instrument while in the shared mode can be transmitted wirelessly to the person on the other end of the call and received by a mobile station on either a separate data channel or over a voice channel itself.

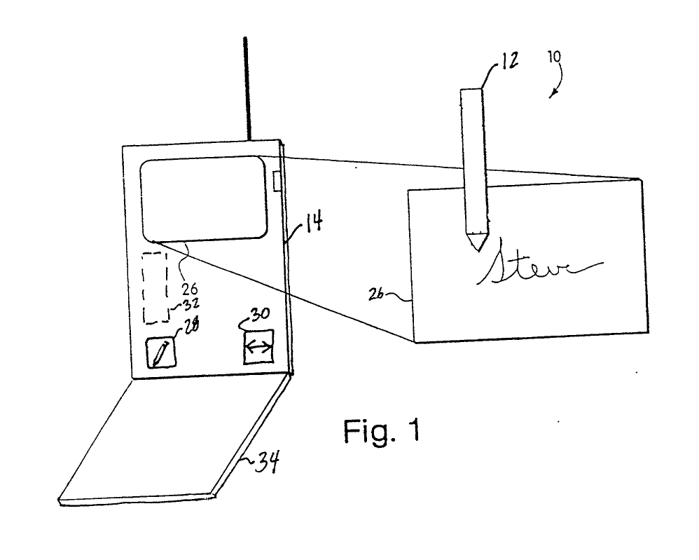

Reference is now made to FIG. 1, wherein there is shown an embodiment of a mobile station 10 in accordance with the present invention. The mobile station 10 includes a stylus 12 and a wireless communication device 14. The wireless communication device 14 includes a screen 26, which can operate in a writing-surface mode or in a display mode. The display mode can include, for example, touch screen functions. The device 14 also includes a control unit 32, which in the embodiment shown in FIG. 1 is internal to the device and which is shown as a dashed box. The control unit 32 is operative to change the screen 26 between the display mode and the writing-surface mode in response to, for example, user input or establishment of a call involving the device 14. The control unit 32 is operative to change the screen 26 to the writing-surface mode and to the display mode in response to a writing-surface-mode change condition and a display-mode change condition, respectively. The device 14 also includes a flip feature 34, which can be adapted to effect a mode change between the display mode and the writing-surface mode.

An enlarged view of the screen 26, while in the writing-surface mode, is also shown in FIG. 1 as indicated by perspective lines. Although the screen 26 is shown as being an integral part of the device 14, the screen 26 can, in embodiments of the present invention, be external to the device 14 and communicate with the device 14 via, for example, a cable, an infra-red link, or a wireless radio link such as Bluetooth™.

In accordance with embodiments of the present invention, upon establishment of a call involving the mobile station 10, the control unit 32 causes the screen 26 to automatically enter into the writing-surface mode so that the user of the mobile station 10 can easily write notes during the call without having to operate a menu or other navigation system. In accordance with some embodiments of the invention, the call can be for example, a video call. If the call is a video call, a portion of the screen 26 can be used in the writing-surface mode, while another portion of the screen can be used as a video monitor.

In an alternative embodiment, the control unit 32 does not cause the device 14 to enter into the writing-surface mode until a dedicated button 28 of the device 14 is pressed. In the alternative, a soft button (not shown) or the like can be accessed by the user for so-called one-click access to the screen in writing-surface mode.

During the call, the user can use the stylus 12 to make drawings or write notes. As described above, these notes can be made available only to the user of the mobile station 10 or can be made available via wireless transmission to a person on the other end of the call. A switch button 30 is also shown on the device 14, which permits the user of the mobile station 10 to switch between the shared mode and the non-shared mode. A soft button (not shown) or the like can also be used to permit switching between the shared mode and non-shared mode.

In addition, in the event that the user of the mobile station 10 wants to continue to write notes after the call has been completed, the user of the mobile station 10 can press the button 28 to cause the control unit 32 to activate the writing-surface mode of the screen 26. Of course, a soft button or the like can also be used to permit access to the screen 26 in writing-surface mode when a call is not ongoing.

In accordance with an embodiment of the invention, when the screen 26 is in the writing-surface mode, the screen 26 can accept text, drawings, or other movements of the stylus 12 on the screen as-is. In an alternative embodiment, the screen 26 can interpret, for example, text or numbers and store the interpreted text or numbers as characters in, for example, a phone directory application.

It can thus be seen from FIG. 1 that embodiments of the present invention permit quick and easy access to a writing function of the device 14. In addition, embodiments of the present invention ensure that the writing function is available and ready to be used when a call is in progress or in response to input by the user. When a call is not in progress or in response to input by the user, the screen 26 of the device 14 can be easily made to return to the display mode so that a menu or other navigation system can be easily accessed.

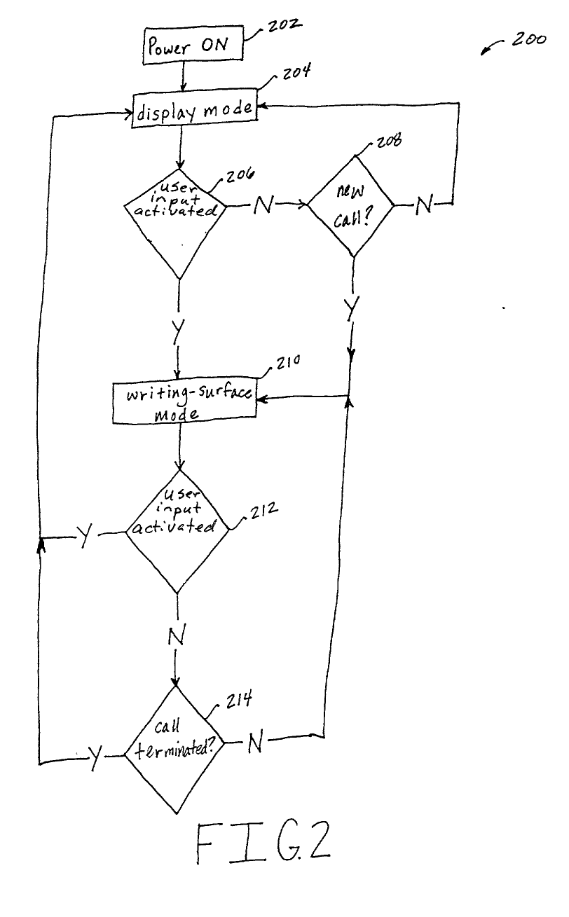

FIG. 2 is a flow diagram that illustrates an exemplary mode of operation of an embodiment of the present invention. A flow 200 begins at step 202, at which step the power to the mobile station 10 is turned on. After the power to the mobile station 10 is turned on at step 202, the screen 26 enters into the display mode. At step 206, a determination is made whether a user input of the mobile station 10, such as, for example, a hard button or a soft button, has been activated. If it is determined at step 206 that the user input has not been activated, at step 208, a determination is made whether a new call has been established. If it is not determined at step 208 that a new call has been established, execution moves to step 204.

If, at step 208, it is determined that a new call has been established, execution moves to step 210. At step 210, the screen 26 enters into the writing-surface mode. At step 206, if it is determined that the user input has been activated, execution proceeds to step 210. Thus, from the display mode, if the user input is activated or it is determined that a new call has been established, the screen 26 switches from the display mode to the writing-surface mode. Although not shown in FIG. 2, the mobile station 10 could be made to enter into the writing-surface mode only in response to the user input being activated by making well-understood modifications to the flow 200.

From step 210, execution proceeds to step 212. At step 212, a determination is made whether the user input has been activated. If it is determined at step 212 that the user input has been activated, execution moves to step 204. If, at step 212, it is determined that the user input has not been activated, execution moves to step 214. At step 214, a determination is made whether an ongoing call has been terminated. If it is determined at step 214 that an ongoing call has been terminated, execution moves to step 204. If, at step 214, it is not determined that an ongoing call has been terminated, either because no call is ongoing at the time the determination of step 214 is made or because a call ongoing at the time the determination of step 214 is made has not yet been terminated, execution moves to step 210. Thus, when the screen 26 is in the writing-surface mode, if the user input is activated or an ongoing call is terminated, the screen 26 enters into the display mode.

Although embodiment(s) of the present invention have been illustrated in the accompanying Drawings and described in the foregoing Detailed Description, it will be understood that the present invention is not limited to the embodiment(s) disclosed, but is capable of numerous rearrangements, modifications, and substitutions without departing from the invention defined by the following claims.

What is claimed is:

1. A method of accessing a writing surface of a mobile station comprising:
establishing a call involving the mobile station; and
providing at least a portion of a screen of the mobile station in a writing-surface mode in response to detection of a writing-surface-mode-change condition, the writing-surface mode-change condition comprising the step of establishing the call, wherein a user of the mobile station has access to the writing surface while involved in the call.

2. The method of claim 1, wherein the writing-surface-mode-change condition further comprises activating a writing-surface-mode user input of the mobile station.

3. The method of claim 2, further comprising providing the screen in a display mode in response to activation of a display-mode user input of the mobile station.

4. The method of claim 3, wherein at least one of the display-mode user input and the writing-surface-mode user input comprises a soft button.

5. The method of claim 4, wherein the screen comprises a touch screen and the soft button comprises a portion of the touch screen.

6. The method of claim 3, wherein at least one of the display-mode user input and the writing-surface-mode user input comprises a hard button.

7. The method of claim 3, wherein the display mode is adapted to include touch screen functions.

8. The method of claim 3, wherein the display-mode user input and the writing-surface-mode user input are identical.

9. The method of claim 3, wherein the display-mode user input and the writing-surface-mode user input are not identical.

10. The method of claim 2, further comprising:
writing information on the writing surface;
storing the information;
terminating the call;
activating a display-mode user input of the mobile station;
in response to the step of activating the display-mode user input, exiting the writing-surface mode.

11. The method of claim 10, wherein at least one of the display-mode user input and the writing-surface-mode user input comprises a soft button.

12. The method of claim 11, wherein the screen comprises a touch screen and the soft button comprises a portion of the touch screen.

13. The method of claim 10, wherein at least one of the display-mode user input and the writing-surface-mode user input comprises a hard button.

14. The method of claim 2, further comprising:
terminating the call; and in response to termination of the call, providing at least a portion of the screen in a display mode.

15. The method of claim 1, farther comprising:
transmitting information written on the writing surface of the mobile station to a second mobile station; and
wherein the call comprises a call involving the mobile station and the second mobile station.

16. The method of claim 15, further comprising providing the screen of the mobile station in a display mode in response to activation of a display-mode user input of the mobile station.

17. The method of claim 16, wherein at least one of the display-mode user input and the writing-surface-mode user input comprises a soft button.

18. The method of claim 17, wherein the screen comprises a touch screen and the soft button comprises a portion of the touch screen.

19. The method of claim 16, wherein at least one of the display-mode user input and the writing-surface-mode user input comprises a hard button.

20. The method of claim 16, wherein the display mode is adapted to include touch screen functions.

21. The method of claim 15, further comprising:
terminating the call; and
in response to termination of the call, providing the screen of the mobile station in a display mode.

22. The method of claim 2, further comprising:
providing the screen of the mobile station in a display mode in response to establishing the call;
wherein the call comprises a call involving the mobile station and a second mobile station; and
transmitting information written on the writing surface of the mobile station to the second mobile station.

23. The method of claim 22, further comprising providing the screen of the mobile station in a display mode in response to activation of a display-mode user input of the mobile station.

24. The method of claim 23, wherein at least one of the display-mode user input and the writing-surface-mode user input comprises a soft button.

25. The method of claim 24, wherein the screen comprises a touch screen and the soft button comprises a portion of the touch screen.

26. The method of claim 23, wherein the display mode is adapted to include touch screen functions.

27. The method of claim 23, wherein at least one of the display-mode user input and the writing-surface-mode user input comprises a hard button.

28. The method of claim 22, further comprising:
terminating the call; and
in response to termination of the call, providing the screen of the mobile station in a display mode.

29. The method of claim 1, further comprising:
terminating the call; and
in response to termination of the call, providing at least a portion of the screen in a display mode.

30. The method of claim 1, further comprising:
writing information on the writing surface;
storing the information;
terminating the call;
activating a display-mode user input of the mobile station;
in response to the step of activating the display-mode user input, exiting the writing-surface mode.

31. The method of claim 30, wherein at least one of the display-mode user input and the writing-surface-mode user input comprises a soft button.

32. The method of claim 31, wherein the screen comprises a touch screen and the soft button comprises a portion of the touch screen.

33. The method of claim 30, wherein at least one of the display-mode user input and the writing-surface-mode user input comprises a hard button.

34. The method of claim 1, further comprising providing the screen in a display mode in response to activation of a display-mode user input of the mobile station.

35. The method of claim 34, wherein at least one of the display-mode user input and the writing-surface-mode user input comprises a soft button.

36. The method of claim 35, wherein the screen comprises a touch screen and the soft button comprises a portion of the touch screen.

37. The method of claim 34, wherein at least one of the display-mode user input and the writing-surface-mode user input comprises a hard button.

38. The method of claim 34, wherein the display mode is adapted to include touch screen functions.

39. The method of claim 34, wherein the display-mode user input and the writing-surface-mode user input are identical.

40. The method of claim 34, wherein the display-mode user input and the writing-surface-mode user input are not identical.

41. A mobile station comprising:
a screen adapted to operate in a writing-surface mode and a display mode; and
a control unit adapted to provide at least a portion of the screen in the writing-surface mode in response to detection of a writing-surface-mode-change condition, the writing-surface-mode-change condition comprising establishment of a call involving the mobile station.

42. The mobile station of claim 41, wherein the writing-surface-mode-change condition further comprises activation of a writing-surface-mode user input of the mobile station.

43. The mobile station of claim 42, wherein the control unit provides at least a portion of the screen in the writing-surface mode in response to a user of the mobile station activating a writing-surface mode user input of the mobile station.

44. The mobile station of claim 43, wherein the writing-surface-mode user input comprises a hard button.

45. The mobile station of claim 43, wherein the writing-surface-mode user input comprises a soft button.

46. The mobile station of claim 43, wherein the writing-surface-mode user input comprises a flip feature.

47. The mobile station of claim 42, wherein the screen comprises a touch screen.

48. The mobile station of claim 47, wherein the touch screen comprises a soft button.

49. The mobile station of claim 42, wherein the screen is provided in the display mode in response to termination of the call.

50. The mobile station of claim 42, wherein the display mode is adapted to include touch screen functions.

51. The mobile station of claim 41, wherein the screen comprises a touch screen.

52. The mobile station of claim 51, wherein the touch screen comprises a soft button.

53. The mobile station of claim 41, wherein the control unit provides at least a portion of the screen in the writing-surface mode in response to detection of an outgoing call involving the mobile station.

54. The mobile station of claim 41, wherein the display mode is adapted to include touch screen functions.

55. The mobile station of claim 41, wherein the screen is provided in the display mode in response to termination of the call.

56. The mobile station of claim 41, wherein the control unit provides at least a portion of the screen in the writing-surface mode in response to detection of an incoming call involving the mobile station.
